(19) United States
(12) Patent Application Publication
(10) Pub. No.: US 2013/0171598 A1
(43) Pub. Date: Jul. 4, 2013

(54) Gait Restore Balls

(71) Applicant: Patrick LoSasso, Los Angeles, CA (US)

(72) Inventor: Patrick LoSasso, Los Angeles, CA (US)

(21) Appl. No.: 13/341,622

(22) Filed: Dec. 30, 2011

(51) Int. Cl. G09B 19/00

(52) U.S. Cl. 434/247

(57) ABSTRACT

The Gait Restore Balls unit is a rehabilitative and ambulation accessory for a walker that provides visual and auditory cues to improve the movement pattern or walking ability of an individual with gait problems caused by physiological or neurological issues. The device has two light-shimmering balls which illuminate in an alternating fashion and provides a visual target for each leg. The user than reaches for the glowing ball with their foot as they stride forward. When struck with the ankle, the Gait Restore Ball chimes a pleasing tone indicating a successful step. The unit includes two illuminating balls (one for each leg), which attach to medical tubing which is attached to the cross bars, allowing for varying stride lengths.

### BACKGROUND

Individuals with neurological conditions such as Parkinson's Disease, Huntington's Chorea, Multiple Sclerosis, traumatic brain injuries (TBI), stroke, etc., often present problems with gait or walking. Studies have shown that visual and auditory cues can help improve the individuals' ability to improve gait and initiate movement.¹ There are commercially available products such as the STEPOVER WAND® which is a device commonly used for individuals with gait related issues, but nothing is available as a walker accessory which provides a visual and auditory cue specific to each leg as does the Gait Restore Balls unit. Often individuals with the above neurological conditions have one side of their body which is more compromised than the other. Thus, the ability to provide stimuli or cue to a specific leg is extremely valuable. The Gait Restore Ball's On/Off switch allows for selection of either the left or right ball. Thus if the individual has one leg that gets stuck, the user can illuminate the appropriate ball to provide a visual and auditory cue to aid in the initiation of movement.

### Design Specifics

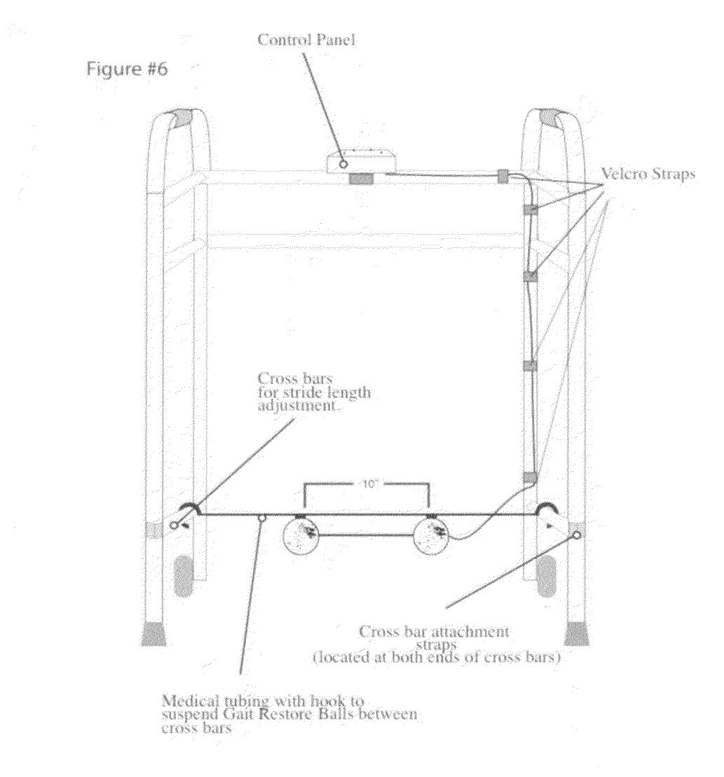

1. The unit is battery powered with easily accessible battery door on the control panel allowing for access of 3 AAA batteries. (See FIG. 3)

2. User may set the unit to activate the sound and light function, only the light function, or only the sound function via the control panel.

3. Sound/light chime is triggered by a magnetic sensor within each Gait Restore Ball which responds to a magnet which is attached user's ankles in the form of an adjustable Velcro ankle strap. When the ankle nears the ball, the device is triggered.

4. Gait Restore Balls are set 10″ apart from each other and connected by a wire which allows for electronic communication. Communication wire is flexible thus allowing for width adjustments less than the 10″ by placing balls closer together along the medical tubing. This accounts for various hip widths and provides proper movement (technique) form and stimuli for gait improvement.

5. Visual cue light illuminates entire ball and is a green glow that flutters and shimmers. Once ball is triggered by a correctly executed step, the light will surge and the chime will sound, and the light will turn off. Subsequently, the opposite side will illuminate.

### ABOUT THE FIGURES

1. Gait Restore Panel face and switch specifications.

2. Control panel front view with Velcro strap which allows the panel to be mounted onto walkers with varying structural support bar widths.

3. Bottom view of the control panel.

4. Gait Restore Balls unit with clips, dimensions and wiring.

5A. Gait Restore Balls mounted on medical tubing shown at maximum 10″ width placement.

5B. Gait Restore Balls mounted on medical tubing shown at a placement of 7″ width.

6. Gait Restore Balls unit mounted on walker with parts notated.

7. Diagram of Gait Restore Balls unit installed.

8. Gait Restore Balls unit in use. (A.) Left ball is illuminated prompting user to swing left leg forward towards ball. Once leg nears ball, a chime sounds, the left ball turns off and the right ball is illuminated (B.).

9A. Ankle strap with clasp and Velcro.

9B. Top down view of ankle strap with strap attached through clasp and fastened by Velcro.

10. Side view of ankle strap attached properly to the ankle.

11. Cross bars with Velcro attachments at either end to affix to the front and back structural legs of a walker. The cross bars are telescopic to adjust to various models and sizes of walkers.

12. Wireless version as described in claim 7.

13. Cross bars in the form of adjustable nylon straps as described in alternate embodiment claim 14.

1. An accessory for a walker that improves gait by providing the user with a visual and an auditory cue for each leg comprising:
a) two illuminating Gait Restore Balls,
b) cross bars which attach to the walker
c) magnetic ankle straps,
d) a control panel,
e) a cross strap or non-specific material such as medical tubing which attaches to the cross bars providing a means to suspend the gait restore balls.

2. The Gait Restore Balls of claim 1 allow for specific and individual visual cueing for each leg as only one light is illuminated at a time so that there is a specific prompt for each step.

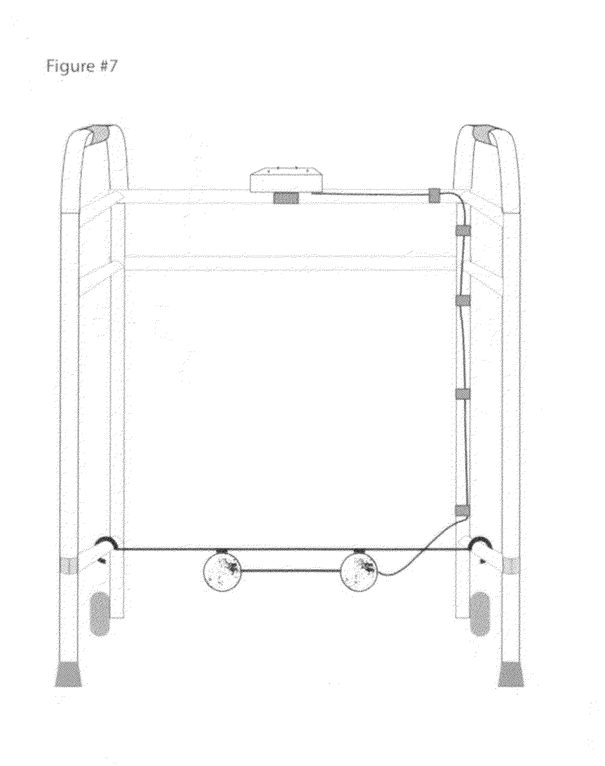

3. The Gait Restore Balls of claim 1 are width adjustable so that the position or distance each ball is from the other can be changed by attaching the Gait Restore Balls individually via a clip or some attachment method to the medical tubing or cross strap which spans the cross bars of claim 1 so that user's hip width can be matched. (See FIGS. 5A & 5B)

4. The Gait Restore Balls of claim 1 may be set to activate the sound and light function, only the light function, or only the sound function via the panel of claim 1.

5. Gait Restore Balls of claim 1 can be adjusted distance wise from each other and are adjustable via a flexible electronic communication wire which connects them and allows for a narrower or wider placement to account for varying hip widths.

6. An alternate embodiment of the Gait Restore Balls in claim 1 will involve a different triggering system in the form of an electronic eye, reflector, and sensor for the light and sound cues.

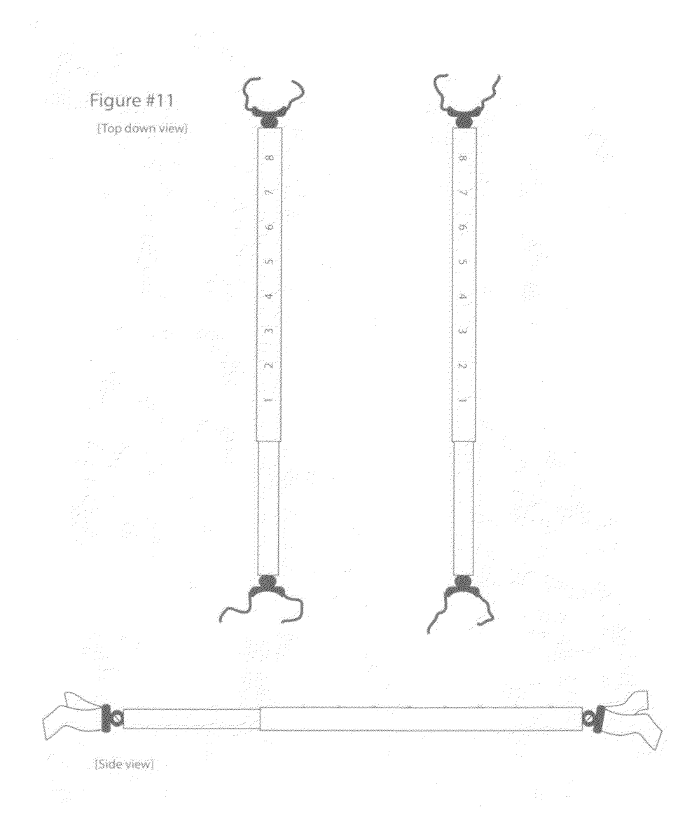

7. An alternate embodiment of the Gait Restore Balls in claim 1 is wireless communication between the control panels and the balls. (See FIG. 12)

8. An alternate embodiment of the Gait Restore Balls in claim 1 is that the triggering of the light and sound function will be caused by motion caused by impact.

9. The control panel of claim 1 allows for turning the Gait Restore Balls on or off and specifying how the Gait Restore Balls will function.

10. The control panel of claim 1 can allow the user to specify which Gait Restore Ball illuminates first, either left ball or right ball, to initiate their stride.

11. The control panel of claim 1 may be set to illuminate both balls and have them and stay illuminated during use so that only the sound chime triggers when leg strikes the gait restore ball.

12. The control panel of claim 1 has an unobvious and unique function called “Exercise Mode” which allows the user to set a metronome pace for the illumination and auditory cueing of the balls (for example: from 10 steps to 140 steps per minute) which the user then attempts to match with their stride.

13. The magnetic ankle straps of claim 1 trigger the light and sound cues by activating a sensor located inside the Gait Restore Balls.

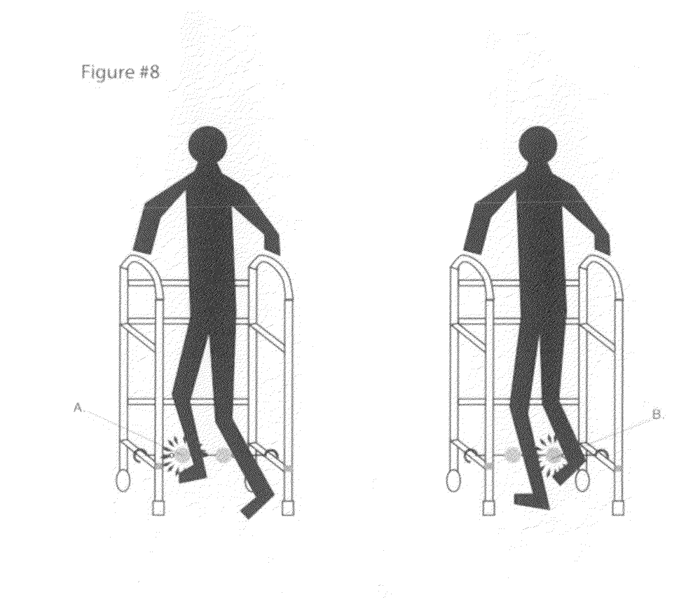

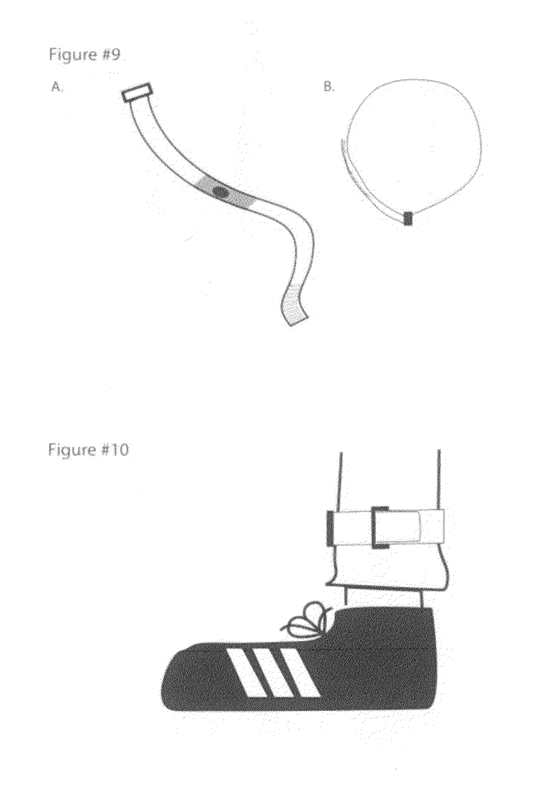

14. The cross bars of claim 1 attach to the walker's front and back legs on each side and allow for adjustment of various stride lengths. (See FIG. 6)

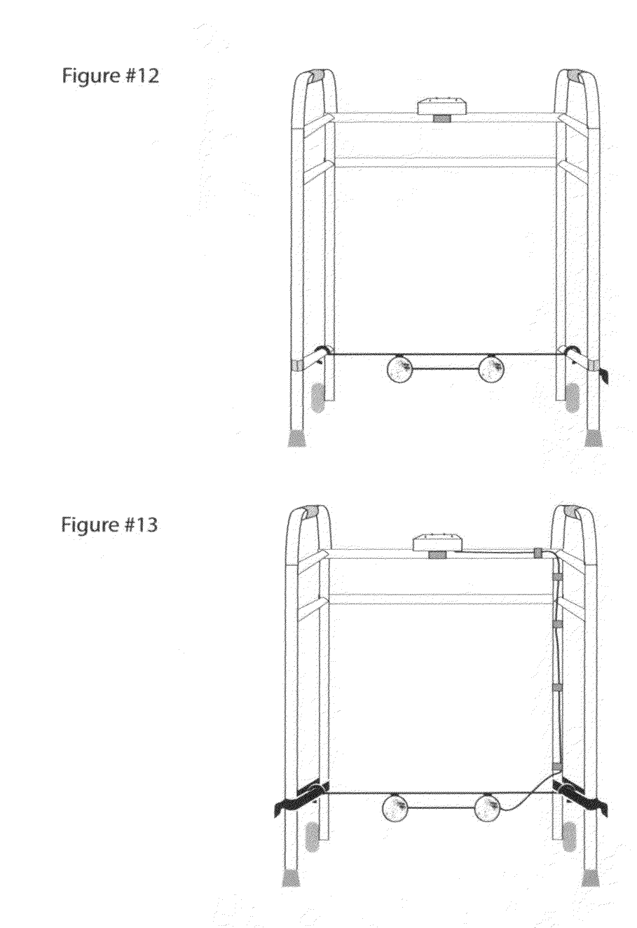

15. Another alternate embodiment will have the adjustable cross bars of claim 1 be of unspecified but material which will attach to the front and back legs of both the left and right sides of the walker, thus serving the purpose of the cross bars of claim 1. (See FIG. 13)

16. Another alternate embodiment will have a communication port for a smart phone, which will allow for controlling the function of the unit and recording the workouts during exercise mode.

17. The “Exercise Mode” of claim 12 also allows user to set the visual and auditory cue to repeat on the same side to allow for repetitive mobilization of a single leg.

18. The “Exercise Mode” of claim 12 also allows user to assign the metronome pace function to trigger the same side repetitive cueing of claim 13 so that the same-side light and sound cues trigger at the designated tempo.

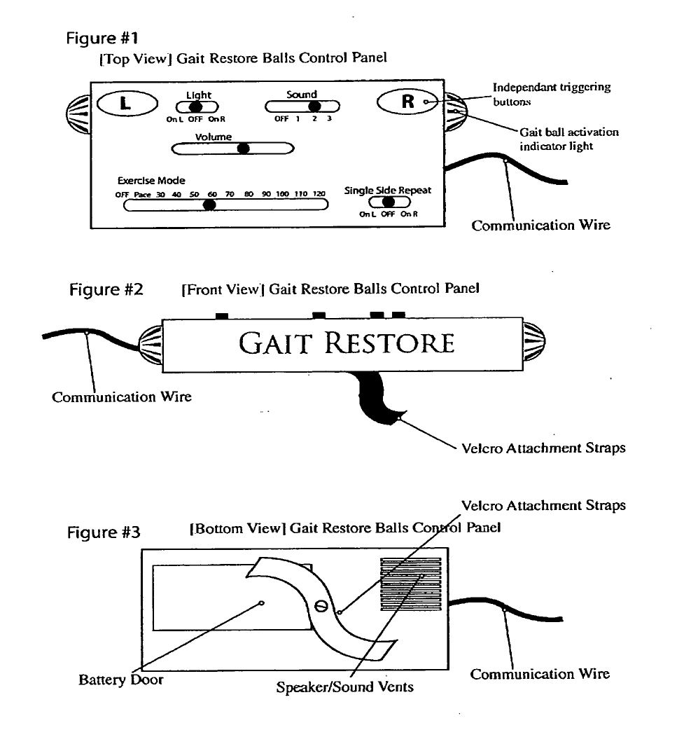

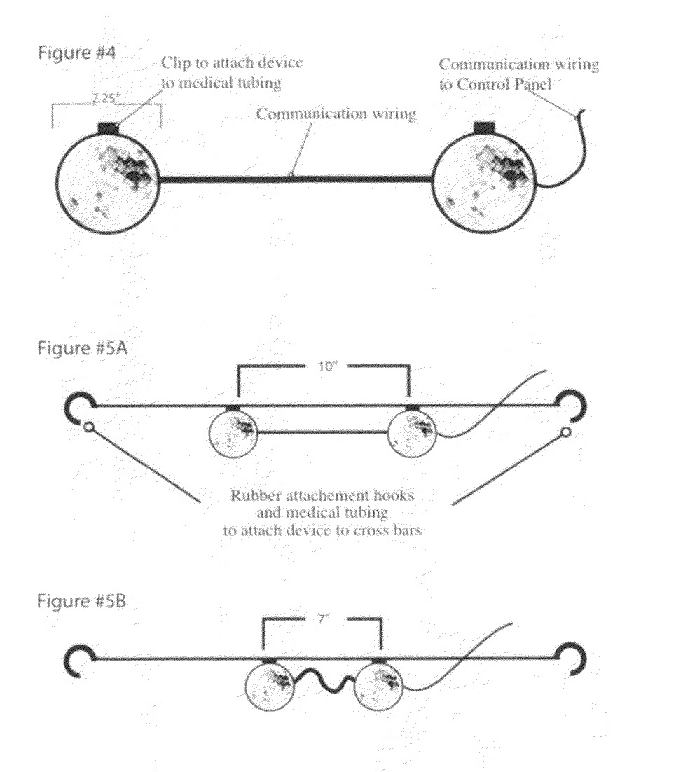

19. The control panel of claim 1 has two indicator lights on the left and right sides of the control panel which illuminate to signal which gait restore ball is currently illuminated and said indicator lights change in sequence with the gait restore balls attached to the cross bars. (See FIG. 1)

20. Another alternate embodiment of the indicator lights located on the control panel in claim 19 will be the ability to reverse the illuminating function so that the opposite side of the illuminated gait restores ball illuminates, thus providing a visual cue for the reciprocal arm. (See FIG. 1)
